(19) United States
(12) Patent Application Publication
(10) Pub. No.: US 2020/0018830 A1
(43) Pub. Date: Jan. 16, 2020

(54) LIGHT DETECTION AND RANGING SENSOR UNIT

(71) Applicants: Conti Temic microelectronic GmbH, Numberg (DE); Continental Automotive GmbH, Hannover (DE)

(72) Inventors: Horst Wagner, Westerstetten (DE); Bernard J. Bojarski, Palatine, IL (US)

(73) Assignees: Conti Temic microelectronic GmbH, Nürnberg (DE); Continental Automotive GmbH, Hannover (DE)

(21) Appl. No.: 16/411,791

(22) Filed: May 14, 2019

(30) Foreign Application Priority Data
Jul. 11, 2018 (EP) 18182862.5

(51) Int. Cl. G01S 7/486; G01S 17/08

(52) U.S. Cl. CPC G01S 7/4863; G01S 17/08

(57) ABSTRACT

A light detection and ranging (“Lidar”) sensor unit having a light signal source, a two dimensional array of a plurality of light sensitive detectors converting impinging light into an electronic signal, a readout integrated circuit, and a processing unit. The readout integrated circuit including a plurality of memory units, each memory unit having an input connected to an output of one of said light sensitive detectors for receiving the electronic signal of the light sensitive detector. Each memory unit also including at least one array with I columns and J rows of analog memory cells, one column select line per column and one row select line per row. Each analog memory cell including an AND-gate with a first input being connected to the corresponding column select line and a second input being connected to the corresponding row select line to select the analog memory cell for write and read.

### CROSS REFERENCE TO RELATED APPLICATION

This application claims the benefit of European patent application No. 18182862.5, filed Jul. 11, 2018, which is hereby incorporated by reference.

### TECHNICAL FIELD

The technical field relates generally to a light detection and ranging sensor unit.

### BACKGROUND

U.S. Pat. No. 9,277,204 discloses a modular laser detection and ranging (“Ladar”) sensor comprising a laser transmitter module, a two dimensional array of light sensitive detectors and a readout integrated circuit with a plurality of unit cell electrical circuits. Each unit cell electrical circuit is capable of amplifying a photocurrent received from a detector and sampling the amplifier output via a plurality of analog memory cells. Each unit cell electrical circuit of the readout integrated circuit contains full address decoder logic and requires the appropriate wiring to connect.

Light or laser detection and ranging sensors are especially useful for advanced driver assistance systems as these sensors do not contain moving parts and show high sensitivity. Ladar sensors may be realized in a compact design, with a high level of reliability and at low costs.

A sequential access memory read out via address pointer is described in detail in U.S. Pat. No. 5,535,170.

To replace defect memory cells it is known from DE 600 01 291 T2 to provide spare memory cell array additionally to a normal memory cell array for self-testing and self-repairing.

As such, it is desirable to present improvements to known Lidar sensors, especially in view of cost-efficiency, reliability and scalability. In addition, other desirable features and characteristics will become apparent from the subsequent summary and detailed description, and the appended claims, taken in conjunction with the accompanying drawings and this background.

### SUMMARY

In one exemplary embodiment, a light detection and ranging (“Lidar”) sensor unit, especially to form part of an advanced driver assistance system, includes a light signal source, a two-dimensional array of a plurality of light sensitive detectors converting impinging light into an electronic signal, a readout integrated circuit, and a processing unit. The readout integrated circuit includes a plurality of memory units, each memory unit having an input connected to an output of one of the light sensitive detectors for receiving the electronic signal of the light sensitive detector. Each memory unit also including an array with at least one column and at least one row of analog memory cells, with one column select line per column and one row select line per row for sampling the electronic signal received. Each analog memory cell including an AND-gate with a first input of the AND-gate being connected to the corresponding column select line and a second input of the AND-gate being connected to the corresponding row select line to select the analog memory cell for write and read.

It should be understood that the AND-gate or AND-function can be made from NAND gates or NOR gates or a combination of NAND-gates and switches. Thus, the sensor unit may use a classical AND-gate and/or a combination of gates that together function equivalent to the AND-gate.

The Lidar sensor unit, depending on the light source, may also termed laser detection and ranging sensor unit or Ladar sensor unit. The Ladar sensor unit employs the light signal source, e.g., a laser source generating pulsed or modulated laser light, to send out light to an object and the array of light sensitive detectors for receiving light reflected from the object. The light sensitive detectors, e.g., photodiodes, may be positioned at a focal plane of receive optics, e.g. a lens assembly and/or a lens array. Each light sensitive detector converts impinging light into an electronic signal, e.g., a photocurrent, and transfers the electronic signal via an output to an input of an ascribed memory unit.

Each memory unit comprises at least one array of analog memory cells, e.g., 128 or 320 or 384 analog memory cells, to sample the electronic signal. According to a preferred embodiment each analog memory cell comprises a capacitance device for storing the analog signal. The analog memory cells are arranged in I columns and J rows along I column select lines and J row select lines. Each analog memory cell is connected to the flanking column select line and the flanking row select line via an AND-gate, i.e. a first input of the AND-gate is connected to the column select line and a second input of the AND-gate is connected to the row select line.

The maximum depth of the sampling of the electronic signal is given by the number of analog memory cells, i.e., the product of the number of columns and rows.

Thus, each analog memory cell can be selected for reading and writing in an easy way utilizing a select signal, e.g., generated by the processing unit. There is no need for creating address pointer or a decoder logic or other complex logic such as level shifters within the analog memory cell array. The inventive memory unit can easily be implemented with any number of rows or columns of analog memory cells, i.e., the number of rows and/or columns of the array of analog memory cells can be scaled without the need of modifying the analog memory cells or the select signal sources. The memory units have a compact design and can be processed cost-efficiently and reliably.

Auxiliary circuitry, such as level shifters, or break-before-make, may be arranged at the edge of the array and therefore does not interfere with the analog signals.

Another advantage is the separation of analog and digital components enabling for an unproblematic and area efficient isolation of analog and digital supply and simplified processing. Furthermore, the yield is improved due to the clean separation of analog and digital circuitry.

The memory units may be utilized in any application in need of a scalable sequentially addressed analog memory array.

In a further embodiment, the processing unit includes a trigger circuit for generating row clock pulses and column clock pulses to sequentially select the row select lines and the column select lines. For example, one clock pulse is generated with completion of each row and a column clock pulse is generated every time a complete trip through the rows has been completed to store the electronic signal as a series of at the most I times J samples subsequent in time in the array of analog memory cells. The trigger circuit may be capable of selective clock gating to save dynamic power.

Pursuant another embodiment, the array of memory cells includes at least one additional row or one additional column of analog memory cells and a corresponding row select line or column select line. In yet another embodiment, the Lidar sensor unit includes a list of at least one address of a defective memory cell of a memory unit to ensure that a column or row with one or more defective analog memory cells is skipped.

It is an advantage that the architecture of the memory units allows for additional/redundant rows or columns of analog memory cells. One additional row or one additional column allows for skipping columns or rows marked as defective, i.e., containing at least one defective analog memory cell and using the additional row or column instead. The list of defective memory cells enables for a controlled skipping of defective cells. Thus, a yield loss of the memory unit is reduced significantly.

It should be understood that the additional row or additional column is an extra row or column added supplementary to the number of rows and columns corresponding to a desired sampling depth. If, for example, the desired sampling depth is 128, a memory unit may have 16 rows and 8 columns plus one additional column to enable skipping of a defect memory cell. For a sampling depth of 320, a memory cells unit may have 16 rows and 20 columns plus the additional column. The additional row or additional column may be addressed during a read or write cycle instead of the defective row or column, i.e., jumping to the additional row or column and then continuing to read/write the columns or rows following the skipped one. Alternatively, when the defective column or row is skipped, continuing the read/write cycle with the following row or column and additionally reading/writing the additional column or row at the end of the cycle, so that no complex logic is required.

In a further embodiment, the processing unit includes a read/write first-in-first-out (“FIFO”) protocol to sequentially write and read the analog memory cells of each memory unit. The FIFO function enables writing and reading the memory unit. Moreover, the FIFO function allows for skipping a column or a row of the array of analog memory cells marked as defective.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is shows a schematic view of a Lidar sensor unit according to one exemplary embodiment; and

FIG. 2 is shows a schematic view of a memory unit according to an exemplary embodiment.

### DETAILED DESCRIPTION

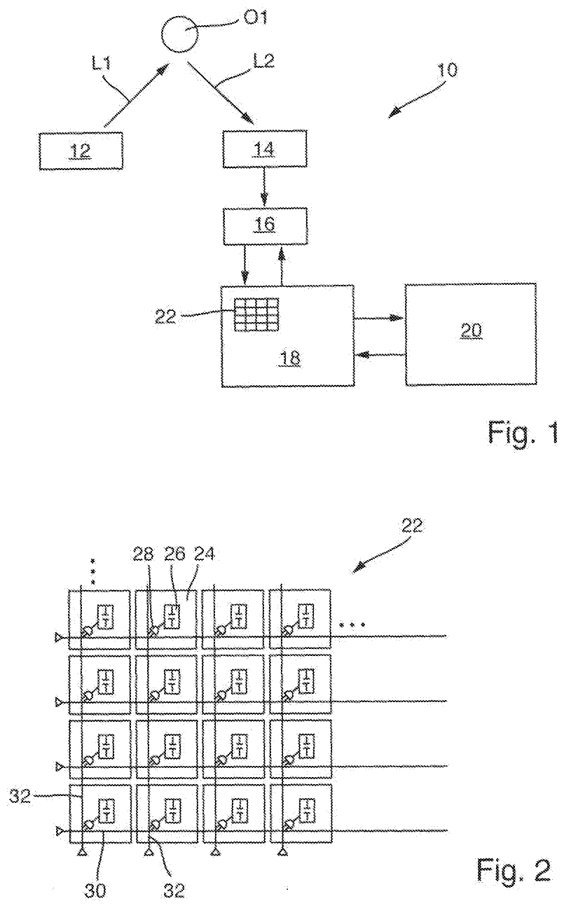

In FIG. 1, a schematic image of a Lidar sensor unit 10 is depicted comprising a light signal source 12 for sending out a light signal L1, a receive optic 14 for receiving a light signal L2 reflected by an object O1, a two-dimensional array 16 of light sensitive detectors, a readout integrated circuit 18, and a processing unit 20.

The two-dimensional array 16 of light sensitive detectors includes N light sensitive detectors, N being an integer, e.g., N being 4096. The readout integrated circuit 18 includes one memory unit 22 per light sensitive detector of the array 16. Each memory unit 22 has an input connected to an output of the corresponding light sensitive detector.

Light impinging on the receive optics 14 is imaged on the array 16 of light sensitive detectors. Each detector converts received light into an electronic signal and transmits the electronic signal to the corresponding memory unit 22.

In FIG. 2, one exemplary embodiment of one memory unit 22 is schematically depicted. Each memory unit 22 comprises an array of I columns and J rows of analog memory cells 24. A column select line 32 proceeds along each column and a row select line 30 proceeds along each row. Each analog memory cell 24 is connected to the adjacent column select line 32 as well as the adjacent row select line 30. Each analog memory cell 24 comprises a capacitance device 26 and an AND-gate 28. A first input of the AND-gate 28 is connected to the corresponding column select line 32 and a second input of the AND-gate 28 is connected to the corresponding row select line 30.

The electronic signal is stored by the array of analog memory cells by sequentially selecting and charging the memory cells. Additional circuitry, such as level shifters, for the sequential selection of the analog memory cells 24 for writing and reading may be arranged at the edge of the array of analog memory cells 24.

As can be seen in the figure, the architecture allows to easily add and address additional rows or columns as well as to skip those rows and/or columns that contain defective analog memory cells.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A light detection and ranging (“Lidar”) sensor unit, comprising
a light signal source;
a two-dimensional array of a plurality of light sensitive detectors converting impinging light into an electronic signal;
a readout integrated circuit comprising
a plurality of memory units, wherein each memory unit comprises an input connected to an output of one of the light sensitive detectors for receiving the electronic signal of the light sensitive detector,
each memory unit further comprising at least one array with at least one column and at least one row of analog memory cells with one column select line per column and one row select line per row for sampling the electronic signal received,
each analog memory cell comprising an AND-gate or a combination of logic gates functioning as AND-gate, a first input of the AND-gate being connected to the corresponding column select line and a second input of the AND-gate being connected to the corresponding row select line to select the analog memory cell for writing and reading; and
a processing unit.

2. The Lidar sensor unit according to claim 1, wherein each light sensitive detector of the array is a photodiode.

3. The Lidar sensor unit according to claim 1, wherein each memory unit comprises at least 128 analog memory cells.

4. The Lidar sensor unit according to claim 1, wherein each analog memory cell comprises a capacitance device for storing an analog signal.

5. The Lidar sensor unit according to claim 1, wherein the processing unit comprises a trigger circuit for generating row clock pulses and column clock pulses to sequentially select the row select lines and the column select lines.

6. The Lidar sensor unit according to claim 1, wherein the array of analog memory cells comprises at least one additional row or one additional column of analog memory cells and a corresponding row select line or column select line.

7. The Lidar sensor unit according to claim 1, further comprising a list of at least one address of a defective analog memory cell of a memory unit.

8. The Lidar sensor unit according to claim 1, wherein the processing unit comprises a read/write FIFO protocol to sequentially write and read the analog memory cells of each memory unit.

9. The Lidar sensor unit according to claim 1, wherein the Lidar sensor unit is part of an advanced driver assistance system.
